(19) United States
(12) Patent Application Publication
(10) Pub. No.: US 2023/0148470 A1
(43) Pub. Date: May 18, 2023

(54) LAWN MOWER

(71) Applicant: TECHTRONIC CORDLESS GP, Anderson, SC (US)

(72) Inventors: Kwok Fan LAM, Kwai Chung (CN); Kar Tat Wong, Kwai Chung (CN); Ping Shan Chen, Dongguan (CN)

(21) Appl. No.: 17/916,906

(22) PCT Filed: Nov. 11, 2020
(86) PCT No.: PCT/CN2020/128128

§ 371 Date: Oct. 4, 2022

(30) Foreign Application Priority Data
Apr. 6, 2020 (HK) 22020005367.0
Sep. 11, 2020 (CN) PCT/CN2020/114671
Oct. 8, 2020 (CN) PCT/CN2020/119865

(51) Int. Cl. A01D 34/00; A01D 34/78; A01D 34/82

(52) U.S. Cl. CPC A01D 34/001; A01D 34/78; A01D 34/006; A01D 34/82; A01D 2101/00

(57) ABSTRACT

The present invention provides a lawn mower for cutting grass and maintaining the lawn surface. The lawn mower has a mower deck, a cutting blade driven by a motor, and a blade changing mechanism. The blade changing mechanism includes a fastener for securing the cutting blade to the motor, a blade securement tool for limiting the cutting blade from rotating, and at least one opening on the mower deck for removably receiving the blade securement tool. An edge guide is also provided on the mower deck. The lawn mower also includes a dynamic power management system configured to adjust a rotation speed of the motor dynamically based on a duty condition of the cutting blade.

### CROSS-REFERENCE TO RELATED APPLICATIONS

This application claims the benefit of the Hong Kong Standard Patent Application No. 22020005367.0, filed on 6 Apr. 2020, the International Application No. PCT/CN2020/114671, filed on 11 Sep. 2020, and the International Application No. PCT/CN2020/119865, filed on 8 Oct. 2020, which are incorporated by reference herein in its entirety.

### TECHNICAL FIELD

The present disclosure generally relates to a lawn mower. More particularly, the present disclosure relates to a power-assisted walk-behind lawn mower with an edge guide and a blade changing mechanism.

### BACKGROUND

Lawn mowers are widely used outdoor power tools for cutting grass and maintaining the lawn surface. Electrically powered lawn mowers may be user-propelling or self-propelling with grass cutting blades rotatably driven by an electric motor above the grass and below the cutting deck of the lawn mower. A handle may be mounted at the rear of the lower housing and extended rearwardly and upwardly for the gardener or operator to control.

Generally, the cutting blades are enclosed within the housing of the cutting deck for preventing any accidental injury of the operator by the rotating blade. The side walls of the housing may extend below the plane of the cutting blade for minimizing the risk. However, this arrangement may limit the effective width of the cutting area. Vegetation growing beyond the effective width, such as along the width of the wheels, cannot be mowed. In the case of using the lawn mower near a walking path, a garden edge, a fence, a wall, or other structures, the cutting blade cannot reach the grass adjacent to the structure due to the distance between the cutting blade and the side wall of the housing.

Furthermore, the cutting blade of the mowing apparatus may wear out after repeated use for cutting shrubs or grass in a lawn and may need to be sharpened or replaced. However, the replacing process can be especially challenging and dangerous to an untrained user. The cutting blade is generally installed to rotate with an output shaft on a plane substantially in parallel to the ground surface. When replacing the cutting blade, the operator is required to hold the cutting blade firmly from rotating and unscrew a fastener carefully. As the cutting blade may be sharp, protective measures should be taken by the operator.

Accordingly, there is a need in the art for a power-assisted lawn mower that seeks to address at least some of the above issues. Furthermore, other desirable features and characteristics will become apparent from the subsequent detailed description and the appended claims, taken in conjunction with the accompanying drawings and this background of the disclosure.

### SUMMARY OF THE INVENTION

Aspects and advantages of the invention will be set forth in part in the following summary, or may be obvious from the summary, or may be learned through practice of the invention.

In accordance with certain embodiments of the present disclosure, a power-assisted walk-behind lawn mower for cutting grass and maintaining the lawn surface is provided. The lawn mower comprises a mower deck, a cutting blade rotatably mounted to the mower deck, a motor for driving the cutting blade, and a blade changing mechanism. The blade changing mechanism includes a fastener for securing the cutting blade to the motor; a blade securement tool for limiting the cutting blade from rotating in at least one direction; and at least one opening at the mower deck for removably receiving the blade securement tool.

In accordance with a further aspect of the present disclosure, the blade securement tool limits the cutting blade from rotating in both directions.

In accordance with a further aspect of the present disclosure, the blade changing mechanism comprises two spaced apart openings.

Preferably, the blade securement tool comprises a U-shaped piece with two side pins, the U-shaped piece crosses the cutting blade when the two side pins are received in the two openings.

Preferably, the U-shaped piece comprises a horizontal member connected between the two side pins, wherein the horizontal member has a length larger than a width of the cutting blade.

In accordance with a further aspect of the present disclosure, the mower deck comprises a motor housing, the at least one opening is provided at the motor housing.

In accordance with certain embodiments of the present disclosure, the lawn mower comprises a mower deck, a cutting blade rotatably mounted to the mower deck, and an edge guide on the mower deck. The cutting blade defines a generally planar cutting area. The edge guide defines a channel extending from an area radially exterior to and below the cutting area to the cutting area.

In accordance with a further aspect of the present disclosure, the edge guide comprises a vertically extending outer guide, the outer guide is radially away from and extends lower than the cutting area.

In accordance with a further aspect of the present disclosure, the edge guide further comprises a combing structure at an inner side of the outer guide for combing and/or converging grass to the cutting area.

Preferably, the combing structure comprises one or more ribs, the one or more ribs divide the channel into two or more sub-channels.

Preferably, the one or more ribs extend at least partially in a radial direction.

Preferably, the two or more sub-channels are tortuous.

In accordance with certain embodiments of the present disclosure, a lawn mower is configured to be powered by one or more battery sources, and comprises a cutting blade, a motor for driving the cutting blade, and a dynamic power management system configured to adjust a rotation speed of the motor dynamically based on a duty condition of the cutting blade such that the rotation speed is a function of a current supplied to the motor.

In accordance with a further aspect of the present disclosure, the dynamic power management system comprises one or more current sensors configured to continuously or regularly measure the current of the motor.

In accordance with a further aspect of the present disclosure, the lawn mower further comprises a processor having a current consumption profile and is configured to determine the rotation speed of the motor by comparing the current of the motor with the current consumption profile.

Preferably, the current consumption profile comprises a plurality of predetermined current ranges or thresholds representing at least a high current consumption and a low current consumption.

In accordance with a further aspect of the present disclosure, the one or more current sensors are attached to a current path to the motor using a shunt resistor or a magnetic device.

In accordance with a further aspect of the present disclosure, the function is selected from a group consisting of: an increasing step function, a continuous monotonically increasing function, or a combination thereof.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Other aspects and advantages of the present invention are disclosed as illustrated by the embodiments hereinafter.

### BRIEF DESCRIPTION OF THE DRAWINGS

The appended drawings contain figures to further illustrate and clarify the above and other aspects, advantages, and features of the present disclosure. It will be appreciated that these drawings depict only certain embodiments of the present disclosure and are not intended to limit its scope. It will also be appreciated that these drawings are illustrated for simplicity and clarity and have not necessarily been depicted to scale. The present disclosure will now be described and explained with additional specificity and detail through the use of the accompanying drawings in which:

FIG. 1 is a perspective view of the lawn mower m accordance with certain embodiments of the present disclosure;

FIG. 2 is a side view of the lawn mower of FIG. 1;

FIG. 3 is a top view of the lawn mower of FIG. 1;

FIG. 4 is a bottom view of the lawn mower of FIG. 1;

FIG. 5 is a perspective view of the horizontal member of the handle of the lawn mower of FIG. 1;

FIG. 6A is a side view of the horizontal member of the handle of the lawn mower of FIG. 1 when the safety bail is pivoted to a higher position;

FIG. 6B is a side view of the horizontal member of the handle of the lawn mower of FIG. 1 when the safety bail is pivoted to a lower position;

FIG. 7A is an exploded perspective view of the control assembly of the lawn mower of FIG. 1;

FIG. 7B is an exploded top view of the control assembly of the lawn mower of FIG. 1;

FIG. 7C is an internal view of the control assembly of the lawn mower of FIG. 1;

FIG. 8A is an internal view of one of the tube connectors having a switch that can be triggered by the pivotal movement of the safety bail;

FIG. 8B is an exploded view of the safety bail and the tube connectors of the lawn mower of FIG. 1;

FIG. 9 is a perspective view of the internal structure of the lawn mower of FIG. 1 with the openable cover of the power module removed;

FIG. 10 is an internal perspective view of the power assembly and the cutting blade of the lawn mower of FIG. 1;

FIG. 11 is an exploded view of the power assembly and the cutting blade of FIG. 10;

FIG. 12A is a bottom front view of a mower deck of the lawn mower of FIG. 1 with the blade securement tool mounted;

FIG. 12B is a rear view of the power assembly of the lawn mower of FIG. 1 that can be mounted with the blade securement tool;

FIG. 12C is a bottom view of the lawn mower of FIG. 1 when replacing the blade using the blade securement tool;

FIG. 13A is a bottom front view of an edge guide of the lawn mower of FIG. 1;

FIG. 13B is a bottom view of the edge guide of FIG. 13A;

FIG. 13C is a perspective view of the edge guide of FIG. 13A;

FIG. 13D is a bottom perspective view of the edge guide of FIG. 13A;

FIG. 13E is a perspective view of the edge guide of the lawn mower of FIG. 1 with an extension portion below the outer guide;

FIG. 14A is a perspective view of the rear wheel;

FIG. 14B is an alternative view of the rear wheel of FIG. 14A illustrating the gear driving mechanism;

FIG. 14C is an exploded view of the rear wheel of FIG. 14A;

FIG. 15 is a front view of the propelling machine installed in the lawn mower of FIG. 1;

FIG. 16 is a front internal view of the propelling machine of FIG. 15 showing the structure of the actuator assembly;

FIG. 17 is an exploded internal view of the propelling machine of FIG. 15;

FIG. 18 is an exploded view of the clutch assembly of the propelling machine of FIG. 15; and

FIG. 19 is a schematic block diagram of the lawn mower in accordance with certain embodiments of the present disclosure.

### DETAILED DESCRIPTION OF THE INVENTION

The following detailed description is merely exemplary in nature and is not intended to limit the disclosure or its application and/or uses. It should be appreciated that a vast number of variations exist. The detailed description will enable those of ordinary skilled in the art to implement an exemplary embodiment of the present disclosure without undue experimentation, and it is understood that various changes or modifications may be made in the function and structure described in the exemplary embodiment without departing from the scope of the present disclosure as set forth in the appended claims.

The benefits, advantages, solutions to problems, and any element(s) that may cause any benefit, advantage, or solution to occur or become more pronounced are not to be construed as a critical, required, or essential features or elements of any or all of the claims. The invention is defined solely by the appended claims including any amendments made during the pendency of this application and all equivalents of those claims as issued.

Terms such as “upper”, “lower”, “inner”, “outer”, “front”, “rear”, “top”, “bottom”, and variations thereof are used herein for ease of description to explain the positioning of an element, or the positioning of one element relative to another element, and are not intended to be limiting to a specific orientation or position.

The present disclosure relates to a structure of a lawn mower or a gardening tool, which is generally designated as 10. More specifically, but without limitation, the present disclosure provides a power-assisted walk-behind lawn mower with a deck height adjustment mechanism. One having ordinary skill in the art would understand that the current disclosure is also applicable to various gardening tools and power equipment, such as blowers, cultivators, tillers, and lawn sweepers.

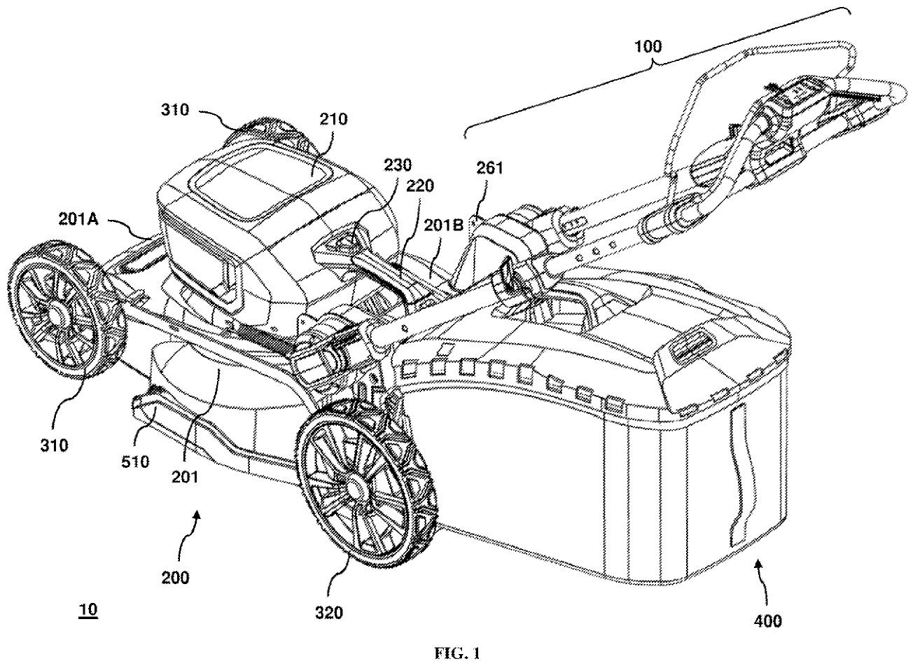

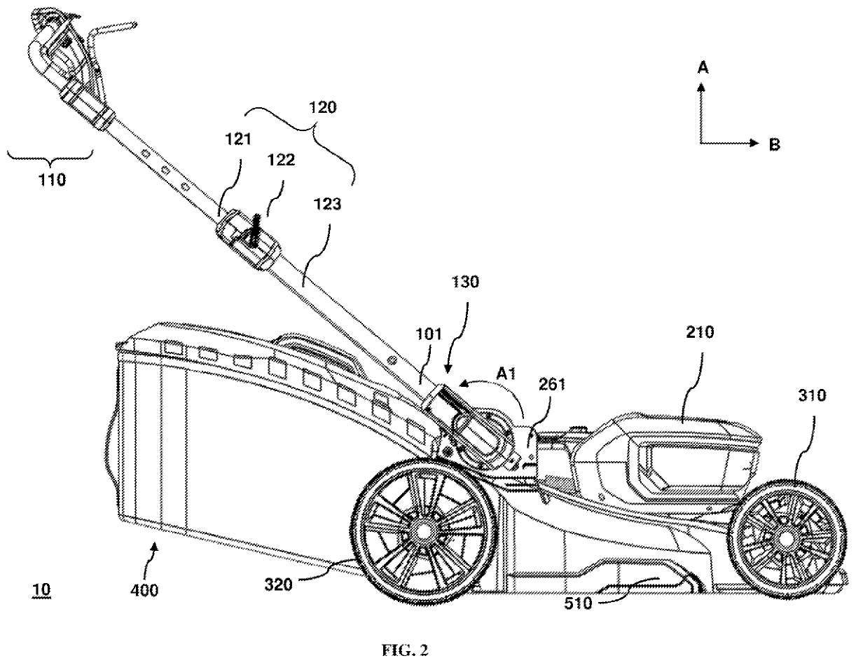

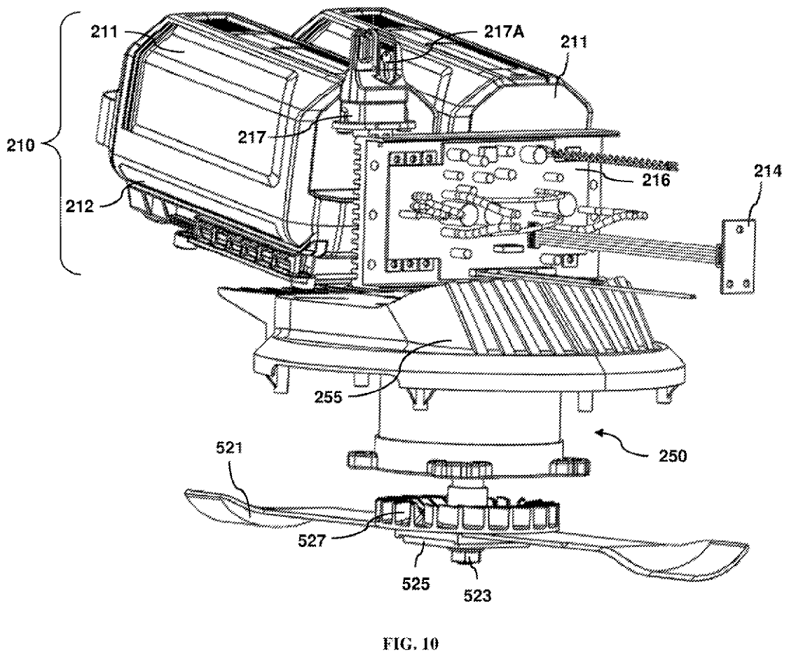

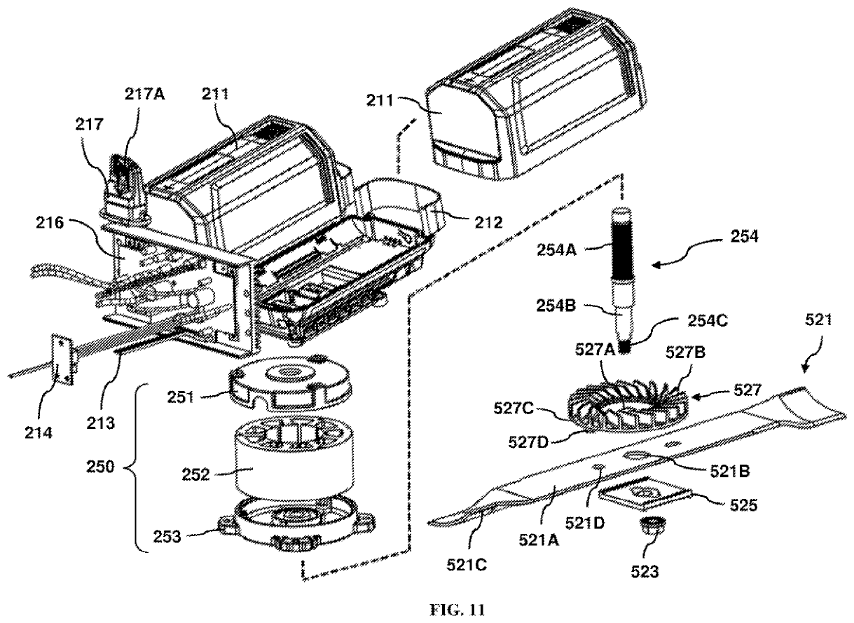

The lawn mower 10 is a walk-behind electric lawn mower arranged to operate on a lawn or a grass growing surface so as to cut the grass. This action is commonly known as “mow the lawn” and is often undertaken by gardeners and landscape workers, or referred to as the “operator”, to maintain a lawn surface. With reference to FIGS. 1 and 2, there is provided a lawn mower 10 comprising a mower body 200 and a handle 100, wherein the mower body 200 is the tool body rest on an operating surface for cutting the grass. The mower body 200 comprises a mower deck 201 having a front end 201A and a rear end 201B. The handle 100 is coupled to the rear end 201B of the mower body 200 comprising one or more mower joints 261. The handle 100 is pivotable relative to the mower body 200 via the one or more mower joints 261. The handle 100 comprises one or more tube assemblies 120 with a horizontal member 110 as a handgrip for the operator to control. The handle 100 is also slidable relative to the mower body 200. As shown in FIG. 10, the lawn mower 10 further comprises a power module 210, a motor 250, and a cutting blade 521, wherein the motor 250 is configured to drive the cutting blade 521. In certain embodiments, the power module 210 is provided on top of the mower deck 201. In certain embodiments, the power module 210 is formed integrally with the mower deck 201. The mower body 200 further comprises a carry handle 220 coupled to the mower deck 201 with an actuator 230 thereon. This would be the most convenient for the operator to lift or lower the lawn mower 10 with the carry handle 220.

As shown in FIG. 2, the mower body 200 defines a longitudinal axis B extending from rear to front of the mower body 200. Furthermore, a vertical axis A that is substantially perpendicular to the longitudinal axis B is also defined. The handle 100 extends at an angle A1 with respect to the longitudinal axis B in a work position. The lawn mower 10 is supported by a wheel arrangement comprising one or more front wheels 310 and one or more rear wheels 320. In the illustrated embodiment, the wheel arrangement includes two front wheels 310 and two rear wheels 320. Preferably, as is the case in this embodiment, the lawn mower 10 is switchable between self-propelling and user-propelling, with a propelling machine 600 arranged to propel the lawn mower 10 on an operating surface via the wheel arrangement. When the lawn mower 10 is switched to user-propelling, the operator pushes the handle 100 forward to move the lawn mower 10 on the operating surface via the wheel arrangement. It is apparent that the wheel arrangement may be formed from various types and combinations of wheels, including tracks (such as in tank tracks), chains, belts (such as in snow belts), or other forms of wheel arrangements.

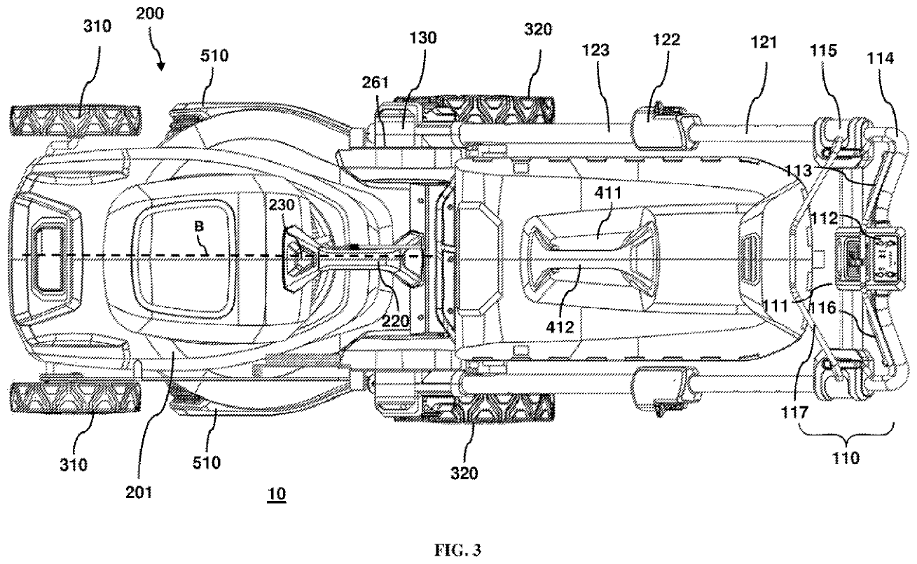

In certain embodiments, a grass collector 400 may be removably attached to the rear portion of the mower deck 201 for collecting the clippings and debris ejected from the lawn mower 10. The grass collector 400 may be essentially a box-like structure made of fabric, plastic, canvas, or other suitable materials. As illustrated in FIG. 3, the grass collector 400 may comprise a cover 411, a collector handle 412, and a capacity indicator. It is within the scope and spirit of the present disclosure that the grass collector 400 may have a different shape provided that the grass collector 400 can perform the function of collecting the clippings and debris ejected from the lawn mower 10. The bottom of the grass collector 400 may have a sheet of metal as a support for carrying the debris. The grass collector 400 may be attached to the rear end 201B of the mower deck 201 using one or more hooks, screws, clips, connectors, and/or other securing elements.

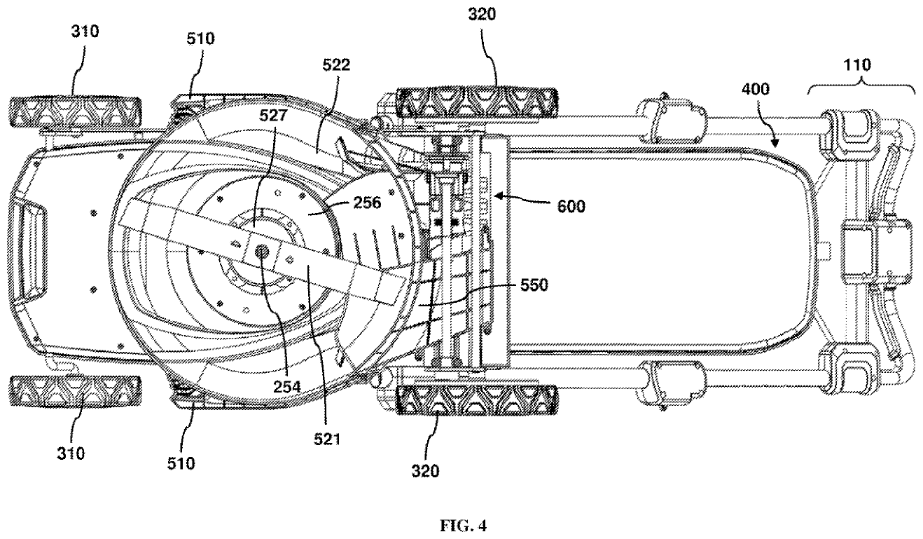

FIG. 4 illustrates the bottom side of the lawn mower 10, which is opened for cutting the grass. A cutting blade 521 is provided in the mower body 200 and are rotatably housed within the cutting area 522 under the mower deck 201. The cutting blade 521 is suspended above the ground at the lower end of an output shaft 254 arranged along the vertical axis A. The mower deck 201 comprises a motor housing 526 for housing the motor 250. The cutting blade 521 is driven by the motor 250 to rotate above the ground and cut the grass. Therefore, the cutting blade 521 is rotatably mounted to the mower deck 201 and defines a generally planar cutting area 522. The resulting grass clippings and debris are driven by airflow produced within the cutting area 522 by the rotation of the cutting blade 521 and an impeller 527, through a discharge chute 550 underneath the mower deck 201, to the grass collector 400.

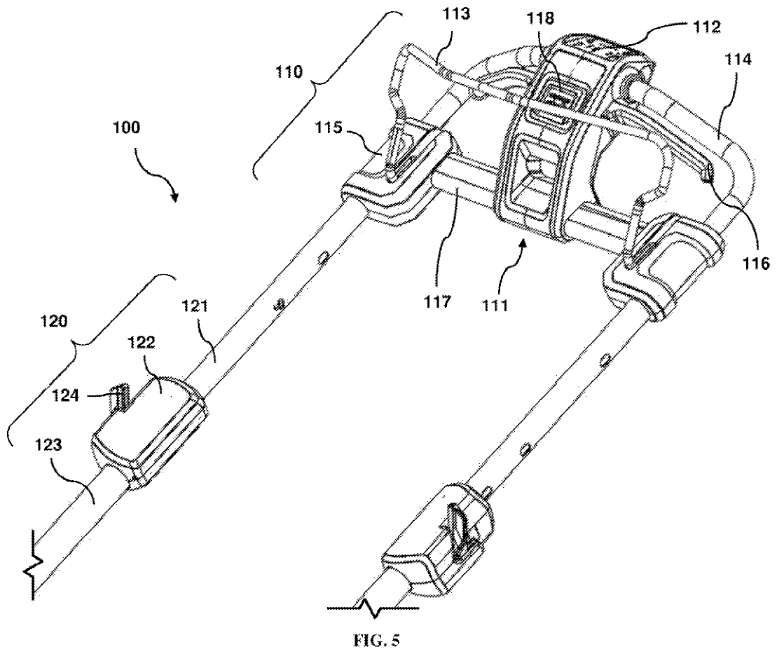

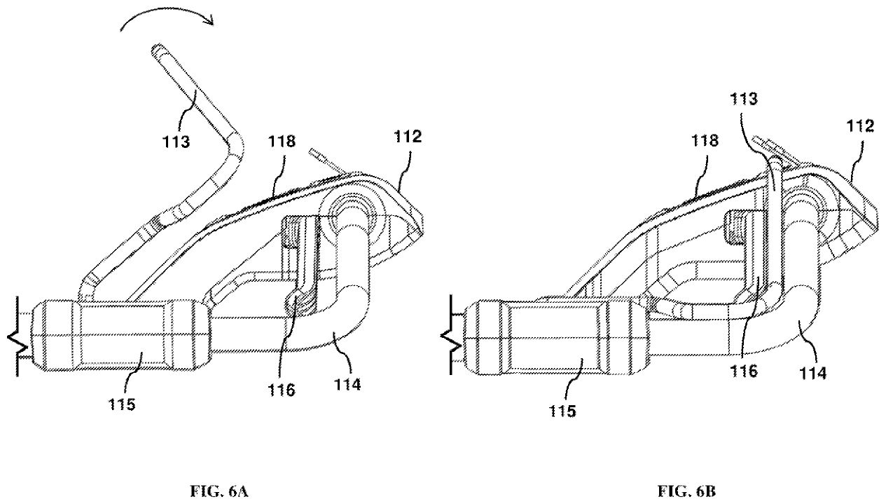

As shown in FIG. 5, the horizontal member 110 is at the distal end of the handle 100 away from the mower body 200. Therefore, the tube assembly 120 as a telescopic tube assembly can be adjusted to position the horizontal member 110 at a height most comfortable to the operator. The horizontal member 110 comprises a crossbar 114, a supporting bar 117, and a control assembly 111 mounted to one or both of the crossbar 114 and the supporting bar 117. Two tube connectors 115 are provided at a distal end of the tube assembly 120 for the supporting bar 117 is arranged horizontally therebetween. The crossbar 114 is substantially a U-shaped bar connected to both ends of the supporting bar 117 for the operator to grip onto, wherein the structure of the U-shaped bar may be raised in the middle, as evident from the drawings, or otherwise be lowered or straightened. In certain embodiments, the crossbar 114 may further be permitted to be pivotally rotated up and down about the supporting bar 117 by turning a pivotal joint (not shown) at the tube connectors 115. In certain embodiments, the control assembly 111 comprises one or more of a safety bail 113, a propelling actuator 116, a cutting actuator 118, and a control panel 112. At least part of the control assembly 111 may be provided at the center of the crossbar 114 and, in certain embodiments, it may also be connected to the supporting bar 117. On the upper surface of the control assembly 111 facing the operator, there may be provided the control panel 112. The control panel 112 may provide indicators to indicate mower statuses, such as battery charge level, self-propelling speed, over current signal, blade change signal or others. The control panel 112 may also provide control buttons to change mower status, such as self-propelling speed adjustment, cutting speed adjustment, or others. The propelling actuator 116 comprises one or two bars extending laterally out of the main body of the control assembly 111. The cutting actuator 118 may be in the form of a spring-loaded button at the main body of the control assembly 111. The safety bail 113 may be pivotable by the operator and restores to its original position by a spring force or other pulling forces when released by the operator. In certain embodiments, only when the safety bail 113 is pivoted by the operator from a higher position as shown in FIG. 6A, to a lower position as shown in FIG. 6B, the lawn mower 10 can be operating by actuating the propelling actuator 116 to start self-propelling, or by actuating the cutting actuator 118 to start cutting. When the safety bail 113 is released, the lawn mower 10 is prevented from being operating. Other ways of configuring the functions of the safety bail 113, the propelling actuator 116, and the cutting actuator 118 are also within the contemplation of the present disclosure.

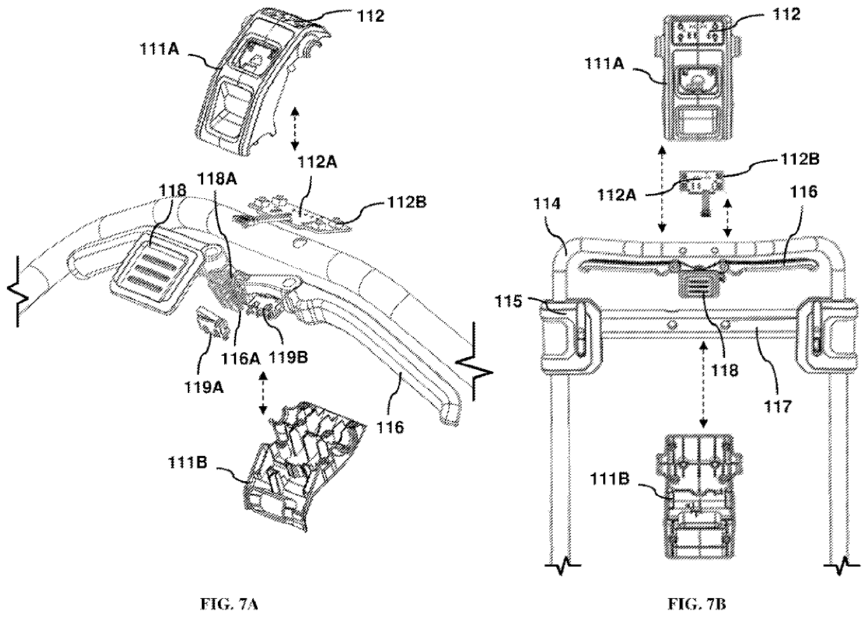

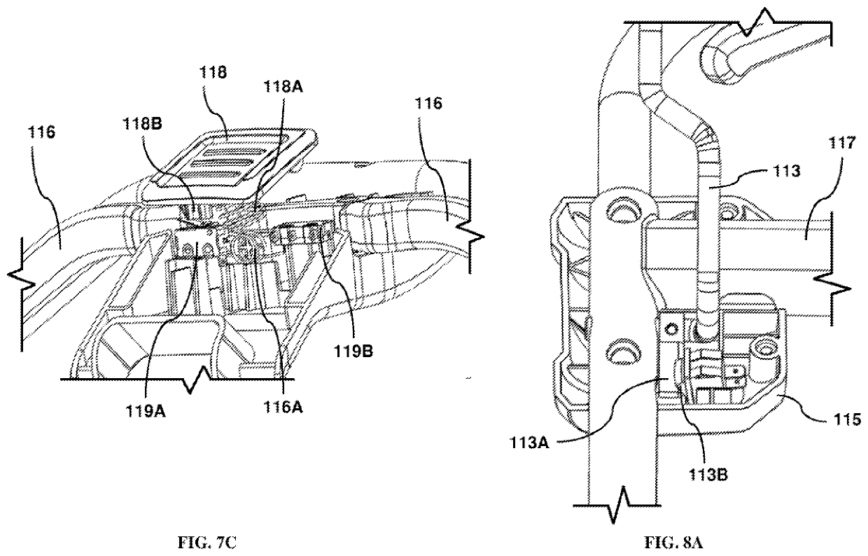

Referring now to FIGS. 7A and 7B, the exploded view of the control assembly 111 is depicted. The control assembly 111 includes a control panel 112, which may comprise a touch screen (not shown) or a plurality of switches 112B and indicators, for selecting and indicating the mode of operation and the speed of each motor. A control circuit board 112A, assembled within an upper housing 111A and a lower housing 111B, is provided to receive the signals from the control panel 112 and electrically connected to the main circuit board 216. As shown in FIG. 7C, the cutting actuator 118 is a push button located on the control assembly 111. The cutting actuator 118 is arranged to cause compression of a first spring 118A, and has a protrusion 118B on the bottom side of the cutting actuator 118 for engaging a first switch 119A. When the cutting actuator 118 is actuated by the operator, it overcomes the resisting force from the first spring 118A and the protrusion 118B actuates the first switch 119A within the main body of the control assembly 111. When the propelling actuator 116 is actuated by the operator, it overcomes the resisting force from a second spring 116A and actuates a second switch 119B within the main body of the control assembly 111.

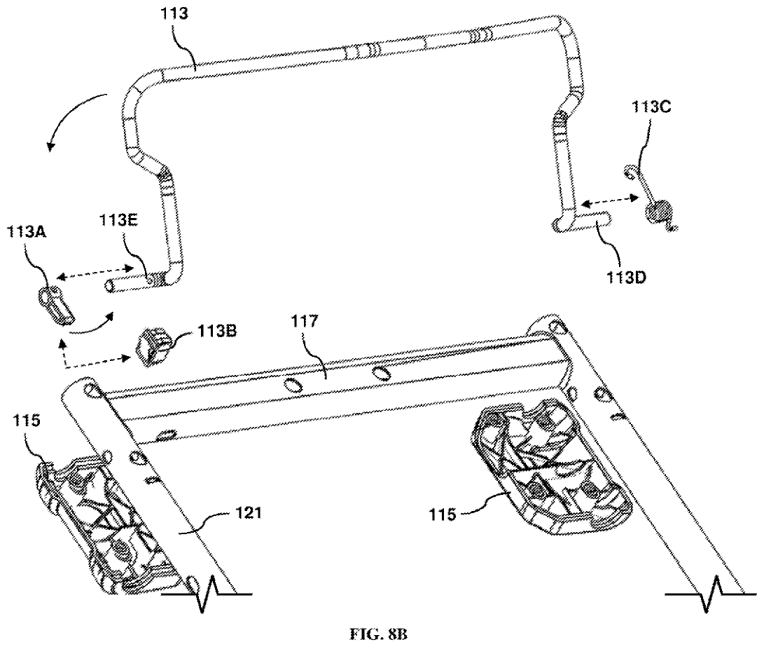

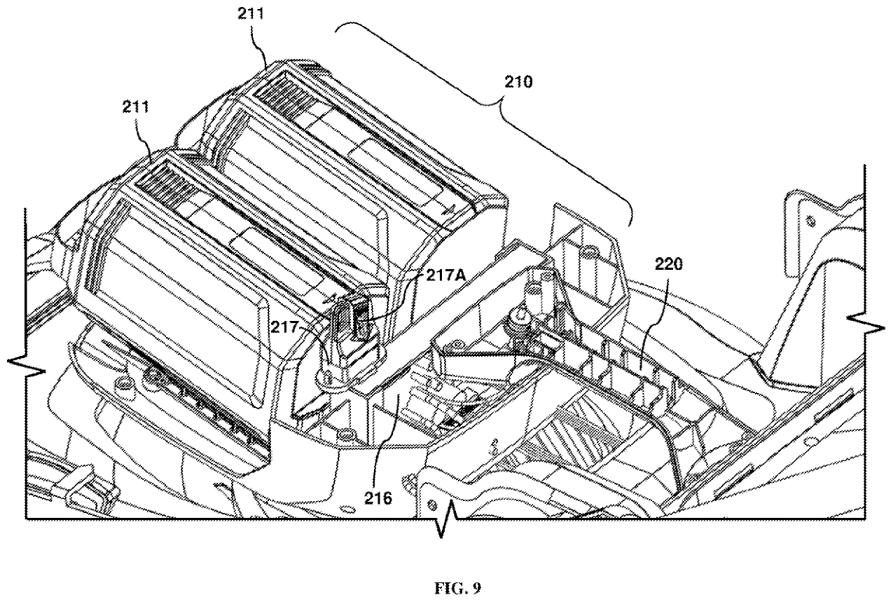

Referring to FIGS. 8A and 8B, the safety bail 113 has at least one end secured to the handle 100, and preferably secured to at least one of the tube connectors 115. A loop spring 113C may be provided at a first pivotal end 113D of the safety bail 113 to pivotally restore the position of the safety bail 113 when it is released. A tab 113A is affixed or otherwise welded to the first pivotal end 113D or the second pivotal end 113E of the safety bail 113, which is coupled with a third switch 113B. When the safety bail 113 is pivoted down with respect to the pivotal ends 113D, 113E from a higher position to a lower position, the tab 113A is pivoted up with respect to the pivotal ends 113D, 113E and actuates the third switch 113. The pivotal movement of the safety bail 113 and the corresponding pivotal movement of the tab 113A are indicated in FIG. 8B.

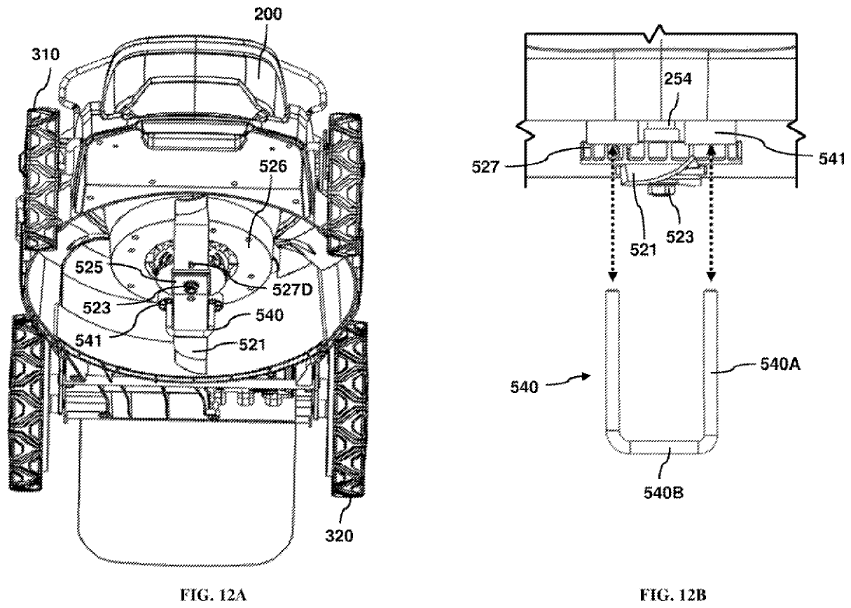

FIG. 9 depicts the structure of the lawn mower 10 around the mower deck 201. It shows part of the power module 210. FIGS. 10 and 11 depict the internal structure and the exploded view of the power module 210, the motor 250, and the cutting blade 521 of the lawn mower 10. The power module 210 comprises one or more battery receptacles 212 for accommodating one or more battery sources 211, a main circuit board 216, and a safety key receiver 217 for receiving a safety key 217A. The power module 210 comprises an openable cover to allow operator's access to the one or more battery sources 211 and the safety key 217A inside the power module 210. The lawn mower 10 is configured to be powered by the one or more battery sources 211. For instance, the electric power from the one or more battery sources 211 is supplied to the main circuit board 216 for driving and/or controlling the motor 250, and/or the propelling machine 600. In one embodiment, the battery source 211 may be a rechargeable lithium-ion battery configured to receive and store energy for powering the lawn mower 10. In certain embodiments, a charging circuit may be included in the lawn mower 10. But the batteries may also be removed from the lawn mower 10 for charging purposes. The one or more battery sources 211 can be installed to or removed from the one or more battery receptacles 212. In certain embodiments, only when the one or more battery sources 211 are properly installed on the battery receptacles 212, and/or the safety key 217A is inserted, then the lawn mower 10 can operate. The mower deck 201 may have one or more air vents or openings for permitting ventilation such that the battery sources 211 can be cooled by air flows. In certain embodiments, at least some of the air vents or openings are provided at the bottom of the power module 210.

The motor 250 may be an electric motor or other suitable engines for driving the cutting blade 521, with or without transmissions. In certain embodiments, the motor 250 comprises an upper housing 251, a stator with a rotor 252, and a lower housing 253. An output shaft 254 comprising a first end 254A and a second end 254B disposed opposite the first end 254A is provided. The output shaft 254 may be supported by two bearings (not shown) respectively placed above and below the rotor 252. the first end 254A is a motor shaft portion configured to engage the motor 250, and the second end 254B is an output portion with a threaded end 254C. The output shaft 254 is used for driving the cutting blade 521 to rotate. For convenience and simplicity, the electrical power and the respective electronic parts have not been shown in the figures. A heat sink 255 having a plurality of heat dissipating fins may be positioned adjacent to the battery sources 211 and the motor 250. In certain embodiments, the heat sink 255 may comprise a plurality of air vents or openings for cooling air to pass through. The size and/or configuration of the air vents or openings is designed not to allow the passing of grass clippings and debris.

The output shaft 254 is coupled to the cutting blade 521 and the impeller 527. The cutting blade 521 is rotatably mounted to the mower deck 201 for cutting the grass across an effective cutting width, which is equivalent to the longitudinal length of the cutting blade 521. The impeller 527 rotates together with the output shaft 254, and functions as an air pump to generate air flows within the cutting area 522. In certain embodiments, such air flows cause cooling air to be drawn from above the mower deck 201, optionally through the motor 250 and the heat sink 255. In certain embodiments, the air flows cause the grass clippings to be directed through the discharge chute 550 to the grass collector 400. The cutting blade 521 includes a body 521A and a blade opening 521B configured to receive the output shaft 254, such that the cutting blade 521 is configured to rotate together with the output shaft 254 on a plane substantially in parallel to the ground surface and along the longitudinal axis B. The body 521A may have a substantially rectangular shape having one or more cutting edges 521C, or with teeth or curved structure. In certain embodiments, the lawn mower 10 may have more than one cutting blade 521 connecting to the output shaft 254 without departing from the scope and spirit of the present disclosure.

The impeller 527 is formed by a circular rotary disc 527C with an impeller opening 527A at the center, and a plurality of impeller blades 527B arranged perpendicular to the circular rotary disc 527C. The plurality of impeller blades 527B are in an arcuate-shape and are evenly spaced apart circumferentially around the circular rotary disc 527C. The output shaft 254 is first inserted into the impeller opening 527A and then the blade opening 521B, thereby the impeller 527 is positioned above the cutting blade 521. Alternatively, it is also possible to have the cutting blade 521 placed above the impeller 527 without departing from the scope and spirit of the present disclosure.

On the second end 254B, a clamp 525 and a fastener 523 are used to secure the cutting blade 521 and the impeller 527 to the motor 250. In particular, the fastener 523 may include a nut and a washer that can be screwed into the thread end 254C of the output shaft 254, and is configured to axially secure the cutting blade 521. On the opposite side of the circular rotary disc 527C, there is provided one or more protrusions 527D arranged to mate with the corresponding one or more mounting holes 521D on the cutting blade 521. The mating can limit the radial or circumferential movement of the cutting blade 521 relative to the impeller 527. Therefore, the impeller 527 is configured to rotate together with the cutting blade 521 after securing with the clamp 525 and the fastener 523.

Due to the repeated use of the cutting blade 521 for cutting shrubs or grass in a lawn, at least a certain portion of the cutting blade 521 may wear out. Therefore, there is a need to disassemble the cutting blade 521 from the mower for sharpening or replacement. However, the blade replacing process can be especially challenging and dangerous to the operator. Conventionally, the operator may need to hold the cutting blade 521 from rotating, and unscrew the fastener 523 with a tightening tool or a motorized tool. Protective gloves or certain tools are usually needed during the blade replacing process. This may cause the blade to be damaged in the process.

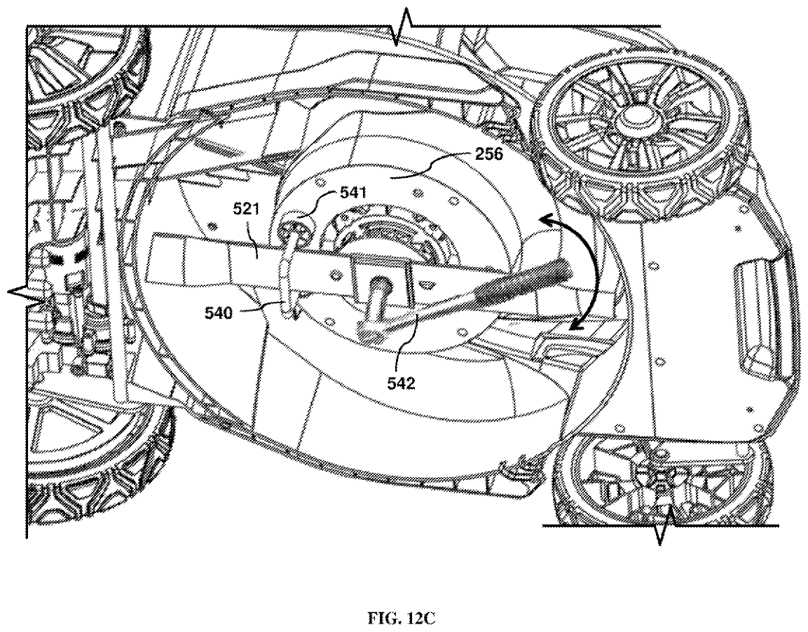

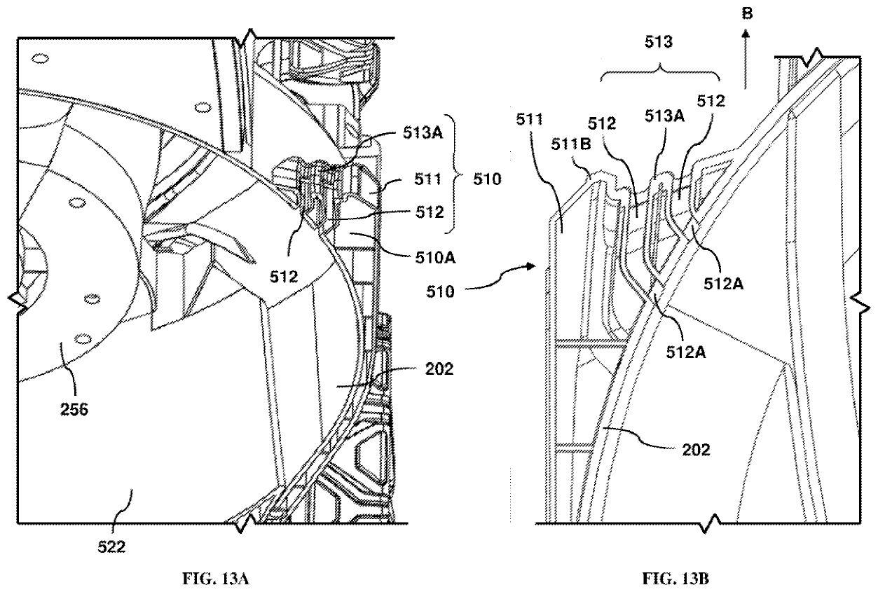

The present disclosure advantageously provides a blade changing mechanism that allows the operator to change the cutting blade 521 safely and conveniently. The blade changing mechanism comprises the fastener 523, a blade securement tool 540, and at least one opening 541 at the mower deck 201. As shown in FIG. 12A, the blade securement tool 540 is mounted across the body 521A of the cutting blade 521 for limiting the cutting blade 521 from rotating in at least one direction, and in the illustrated embodiment, the blade securement tool 540 limits the cutting blade 521 from rotating in both directions. The at least one opening 541 is provided for removably receiving the blade securement tool 540, preferably on the motor housing 526. Referring to FIG. 12B, the blade securement tool 540 comprises a U-shaped piece with two side pins 540A and a horizontal member 540B. The at least one opening 541 comprises two spaced apart openings arranged to receive the two side pins 540A. The horizontal member 540B is connected between the two side pins 540A with a length larger than the width of the cutting blade 521. The U-shaped piece crosses the cutting blade 521 when the two side pins 540A are received in the two openings 541. Therefore, the rotation of the cutting blade 521 can be limited by mounting the blade securement tool 540 across the cutting blade 521. As illustrated in FIG. 12C, after securing the position of the cutting blade 521 with the blade securement tool 540, the operator can use a tightening tool 542, such as a spanner, a wrench, a screwdriver, or the like, to unscrew the fastener 523 from the threaded end 254C. Similarly, the blade changing mechanism can also be used when assembling the cutting blade 521 to the lawn mower 10. The operator first mounts the cutting blade 521 onto the output shaft 254 under the mower deck 201 by mating the one or more protrusions 527D with the corresponding one or more mounting holes 521D on the cutting blade 521. Then the clamp 525 is used to secure the cutting blade 521, and the blade securement tool 540 is used to limit the rotation of the cutting blade 521. The operator can now easily screw the fastener 523 to complete the installation of the cutting blade 521.

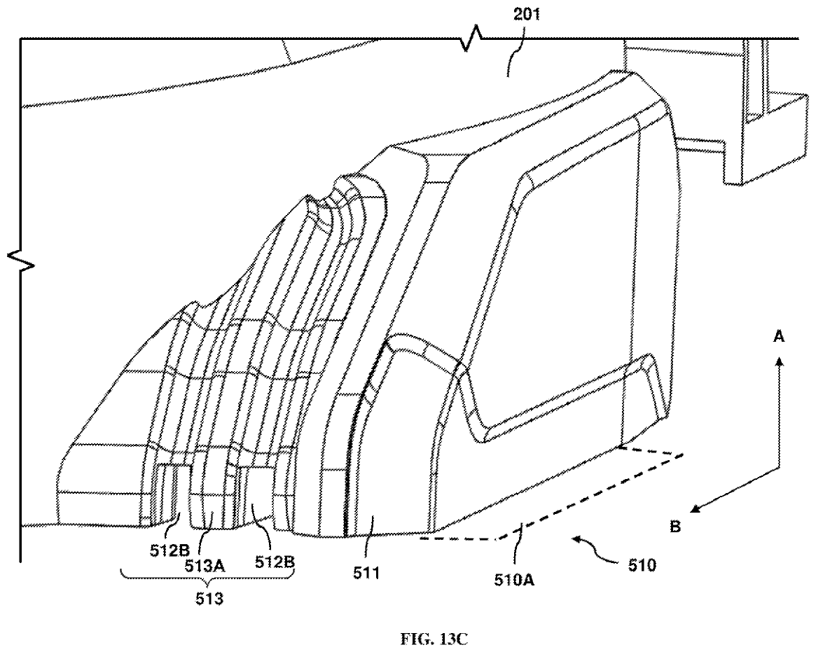

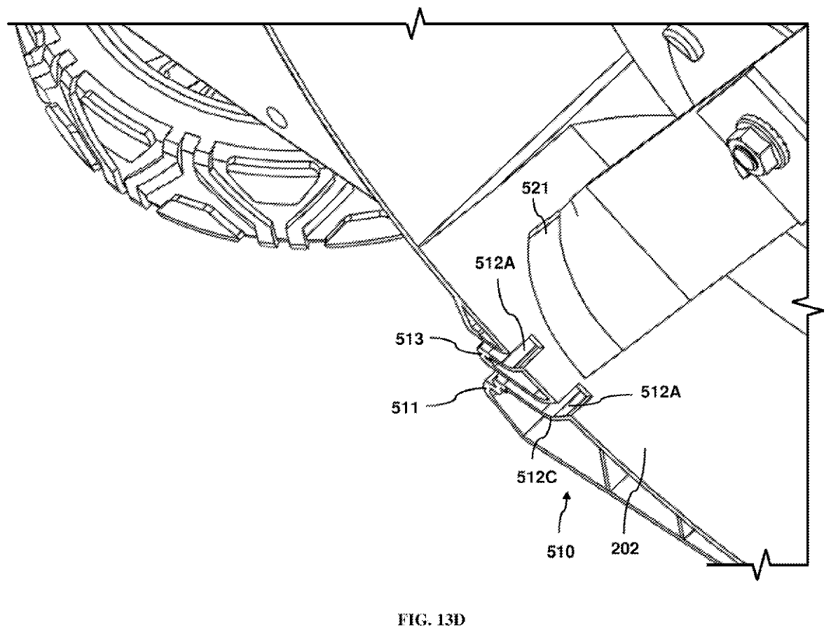

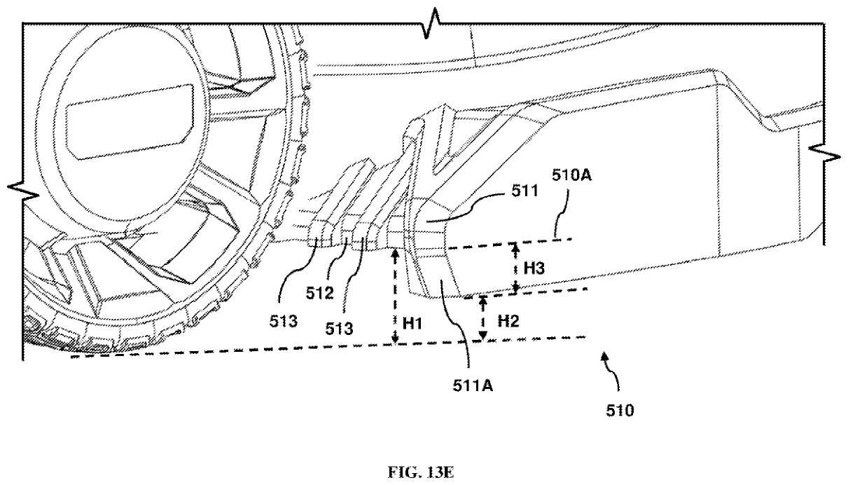

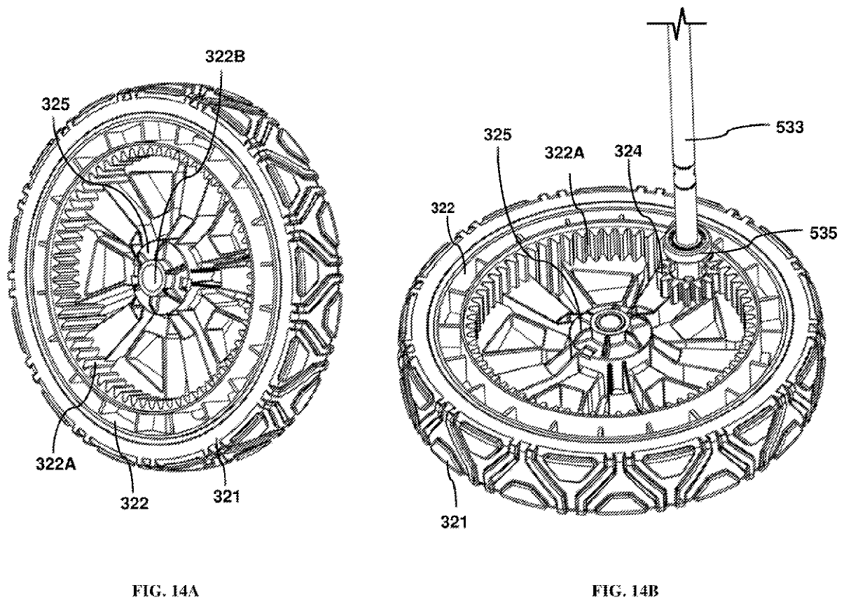

The lawn mower 10 of the present disclosure comprises one or more edge guides 510, each edge guide 510 defines a channel extending from an area radially exterior to and below the cutting area 522 to the cutting area 522. The edge guide 510 can improve the cutting of shrubs or grass outside the cutting area 522 of the lawn mower 10, wherein the cutting area 522 is a generally planar area defined by the cutting blade 521. This is particularly useful when the lawn mower 10 mows along a boundary, such as a walking path, a garden edge, a fence, a wall, or other structures. As shown in FIGS. 13A and 13B, the edge guide 510 is located at each of the left and right sides of the lawn mower 10, and is configured to guide the grass outside the cutting area into the cutting area 522. The mower deck 201 may have different shapes with a side wall 202 surrounding the cutting area 522. As shown in the illustrated embodiments, the mower deck 201 has a circular shape, and the edge guides 510 are positioned adjacent to the perimeter of the annular side wall 202. The edge guide 510 extends tangentially from the periphery of the annular side wall 202 and generally in parallel with the longitudinal axis B. In certain embodiments, the mower deck 201 may be in the shape of a rectangular or a square, while the edge guides 510 may be provided adjacent to or within the side wall at the front corners (not shown). The edge guide 510 is formed integrally with the mower deck 201. Alternatively, the edge guide 510 may also be a discrete element welded or otherwise affixed to the side wall 202 of the mower deck 201. The edge guide 510 is operable to guide the grass outside the mowing area into the cutting area 522 under the mower deck 201 for the cutting blade 521 to cut.

In certain embodiments, the edge guide 510 comprises a vertically extending outer guide 511 and a combing structure 513 at an inner side of the outer guide 511 for combing and/or converging grass to the cutting area 522. In certain embodiments, the outer guide 511 has a tapered protruding portion 511B that extends further forward than the combing structure 513 for better converging the grass to the combing structure 513. The combing structure 513 comprises one or more ribs 513A built on a generally planar base 510A. The planar base 510A is extended from the base of the side wall 202, which is better illustrated in FIG. 13C. In certain embodiments, the one or more ribs 513A divide the channel into two or more sub-channels 512, and may extend at least partially in a radial direction. In certain embodiments, the two or more sub-channels 512 are tortuous. When the lawn mower 10 moves forward to perform the cutting of the grass, the edge guide 510 can guide the grass near the left and right edges of the mower inward and into the cutting area 522 under the mower deck 201.

Each of the two or more sub-channels 512 may include an opening 512B between the outer guide 511 and the one or more ribs 513A for easing the grass to pass through and guide to the cutting area 522. Referring to the bottom perspective view in FIG. 13D, the sub-channel 512 may further comprise a bent channel 512C and a cutout 512A on the side wall 202. As the edge guide 510 is built on the same planar base 510A as the side wall 202, the cutout 512A provides an opening for the grass to enter into the cutting area 522.

In an alternative embodiment, the outer guide 511 and the one or more ribs 513A may protrude above and/or below the planar base 510A. As shown in FIG. 13E, the outer guide 511 comprises an extension portion 511A protruding below the planar base 510A by an extension height H3. The extension portion 511A may be a vertically extended guiding wall extending vertically along an axis perpendicular to or substantially perpendicular to the longitudinal axis B. Similarly, each of the one or more ribs 513A may also has an extension protruding below the planar base 510A (not shown). The two or more sub-channels 512 are above the ground surface by a first vertical height H1, whilst the outer guide 511 with the extension portion 511A is above the ground surface by a second vertical height H2. The first vertical height H1 is larger than the second vertical height H2, thereby the outer guide 511 is closer to the ground surface than the bottom of the mower deck 201. With the difference between the first vertical height H1 and the second vertical height H2, the two or more sub-channels 512 are defined and formed below the planar base 510A, thereby cutout 512A on the side wall 202 is not needed to comply with the safety standard required.

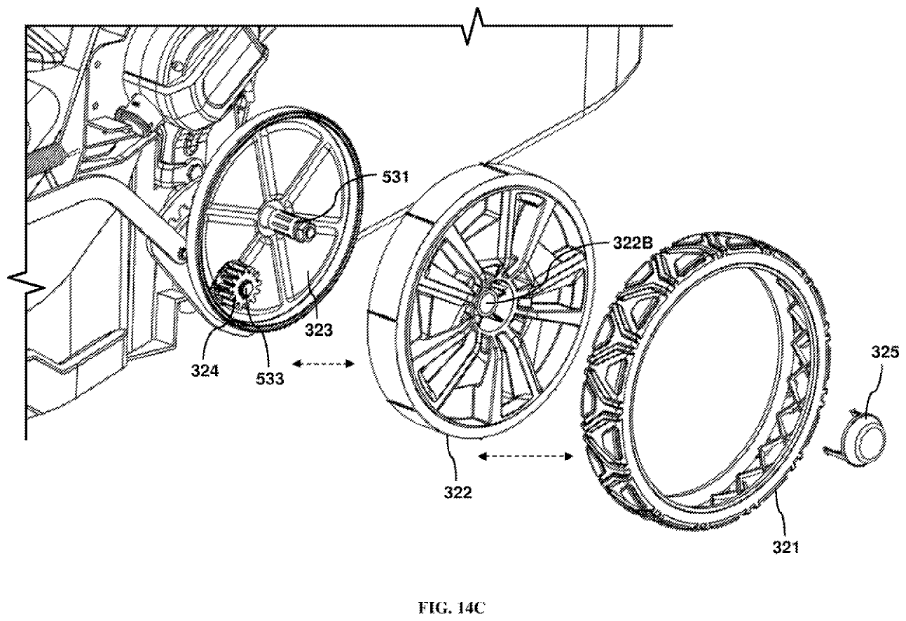

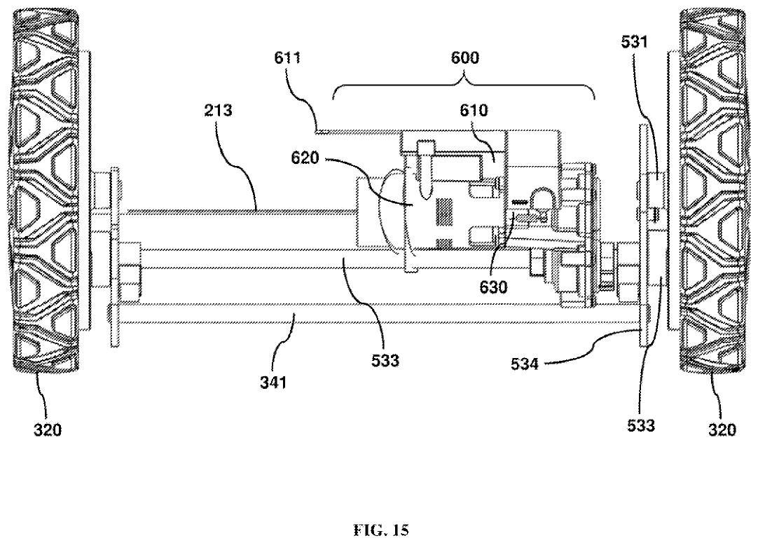

With reference to FIG. 14A, at least one of the rear wheels 320 has a tire 321, a wheel rim 322, and a hub 325. The outer circumferential surface of the wheel rim 322 is configured to receive the tire 321. The wheel rim 322 is mounted to the hub 325 through its inner circumferential surface. In certain embodiments, either or both of the tire 321 and the hub is formed integrally with the wheel rim 322. The hub 325 has an axle hole 322B at the center of the wheel rim 322 for receiving a wheel shaft 531, wherein the rear wheel 320 is allowed to rotate freely about the wheel shaft 531. The inner circumferential surface of the wheel rim 322 is further provided with internal gear teeth to form an internal ring gear 322A. Referring to FIG. 14B, a pinion 324 engages the internal ring gear 322A eccentrically from a central axis of the wheel shaft 531. The external gear teeth of the pinion 324 are in mesh with the internal gear teeth of the internal ring gear 322A, such that when the pinion 324 rotates about the driving shaft 533, the wheel rim 322 is rotated about the wheel shaft 531 accordingly at a reduced speed than the pinion 324. Therefore, the driving shaft 533 is configured to rotatably drive at least one of the pair of rear wheels 320, which drives the lawn mower 10 forward. In certain embodiments, the pinions 324 are provided at both ends of the driving shaft 535, therefore both rear wheels 320 can be driven to rotate around the wheel shaft 531.

FIG. 14C shows an exploded view of the rear wheel 320 in accordance with the present disclosure. A back cab 323 (not shown in FIGS. 14A and 14B) is mounted on the internal side of the rear wheel 320 to cover the pinion 324 and the internal ring gear 322A. The back cab 323 prevents grass clippings and debris from entering and blocking the meshing between the pinion 324 and the internal ring gear 322A of the wheel rim 322. Shaft openings are provided on the back cab 323 for the driving shaft 533 and the wheel shaft 531 to connect into the rear wheel 320. A wheel hub cap 325A is placed at the end of the wheel shaft 531.

The propelling machine 600 in accordance with the present disclosure is shown in FIG. 15, which is installed to output the driving torque to the driving shaft 533. As the driving shaft 533 is set to rotate together with the pinion 324, the rear wheel 320 is driven by the pinion 324 when engaged with the internal ring gear 322A. The propelling machine 600 comprises a driving motor 620, a clutch assembly 630, and an actuator assembly 610. The propelling machine 600 is configured to be powered by the one or more battery sources 211, which receives the electric power via the plural electric wires 213 from the main circuit board 216. The driving motor 620 transfers the driving torque to the clutch assembly 630.

In certain embodiments, the lawn mower 10 is switchable between self-propelling and user-propelling. This is achieved by the actuator assembly 610 by engaging or disengaging the clutch assembly 630. The actuator assembly 610 may be an electromagnetic actuator, an electrical actuator having a solenoid, or a mechanical actuator having a pull wire. When the clutch assembly 630 is adjusted to an engaged configuration, the lawn mower 10 is in self-propelling mode. When the clutch assembly 630 is adjusted to a disengaged configuration, the lawn mower 10 is in user-propelling mode, and the rear wheels 320 are free to rotate. The actuator assembly 610 may also provide an enable signal for activating the driving motor 620 when the clutch assembly 630 is in the engaging configuration. By way of this arrangement, the actuator assembly 610 is operable to activate the driving motor 620 and clutch assembly 630 for driving the rear wheels 320.

A mode selection wire 611 is an electric wire connected to the propelling machine 600 from the propelling actuator 116, which is selectable by the operator to switch the lawn mower 10 between a self-propelling mode and a user-propelling mode. Therefore, the actuator assembly 610 receives a mode selection signal via the mode selection wire 611.

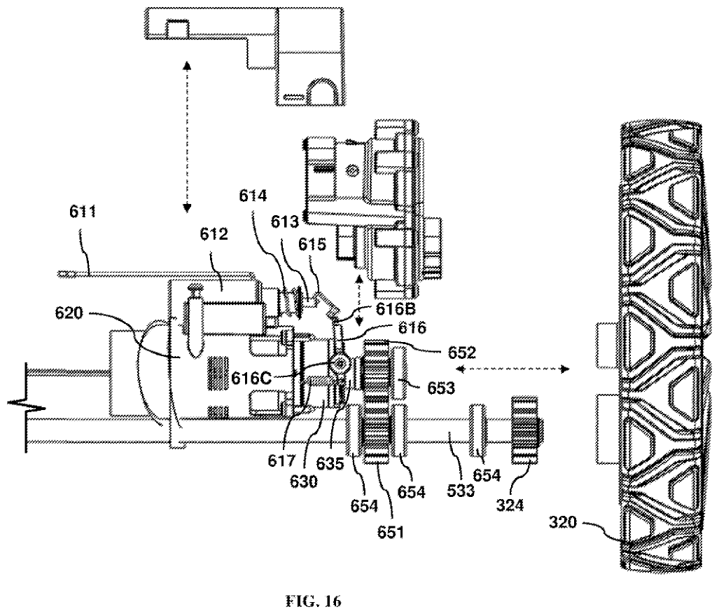

FIG. 16 shows the internal structure of the actuator assembly 610 in accordance with the present disclosure. The actuator assembly 610 comprises an electromagnetic actuator 612, a hook 615, an actuator spring 614, a locking member 616, and a reset spring 617. The mode selection wire 611 is connected to an electromagnetic actuator 612, which comprises a cylindrical housing supported on the driving motor 620, a solenoid, and a piston 613 movable between an extended position and a retracted position along the longitudinal length of the electromagnetic actuator 612 by an induced electromotive force. The piston 613 is connected to a hook 615 with an actuator spring 614 biasing and surrounding the piston 613 for restoring the piston 613 to an extended position when the electromagnetic actuator 612 is disabled.

When the electromagnetic actuator 612 receives an inoperative instruction, the piston 613 is in the extended position to push the hook 615 forward. When the electromagnetic actuator 612 receives an operative instruction, the electromagnetic actuator 612 is activated and the piston 613 is moved to the retracted position to pull the hook 615 rearward. The locking member 616 has a catch 616B connected to the hook 615 on the upper side, which is rotatable about a pivot joint 616D for locking or unlocking the clutch assembly 630. On at least one of the fork end 616A of the locking member 616, a reset spring 617 is attached thereto for restoring the position of the locking member 616.

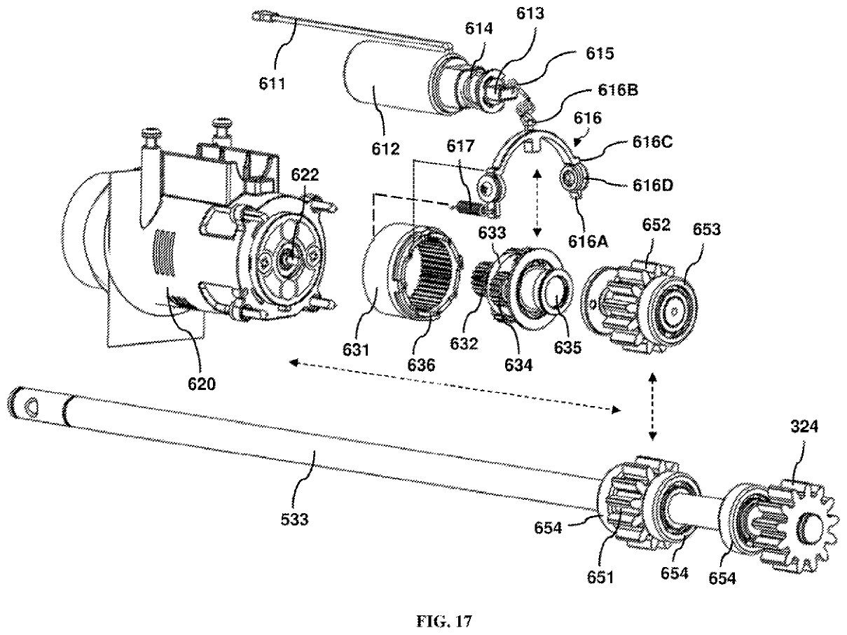

As shown in FIG. 17, the locking member 616 comprises protrusions 616C protruding out from the circumference of the fork end 616A for interlocking the clutch assembly 630. When the piston 613 is moved to the extended position, the catch 616B is moved to a first direction to disengage the protrusion 616C. When the piston 613 is moved to the retracted position, the catch 616B is moved to a second direction to engage the protrusion 616C. The clutch assembly 630 is adjustable between an engaged configuration and a disengaged configuration, wherein the driving torque is transferred from the driving motor 620 to the output shaft 533 in the engaged configuration, and wherein the driving torque is not transferred between the driving motor 620 and the output shaft 533 in the disengaged configuration. The clutch assembly 630 receives the driving torque from the driving motor 620, and when in the engaged configuration, drives the output shaft 635 and the output gear 652 fixed co-axially and supported by a ball bearing 653. The output gear 652 meshes with a shaft gear 651 on the driving shaft 533 so that the driving torque on the output gear 652 is transferred to the driving shaft 533. In certain embodiments, the output gear 652 and the shaft gear 651 are the same in the number of teeth so that the gear ratio is 1 to 1. The shaft gear 651 is also supported by a plurality of ball bearings 654, as shown in the illustration.

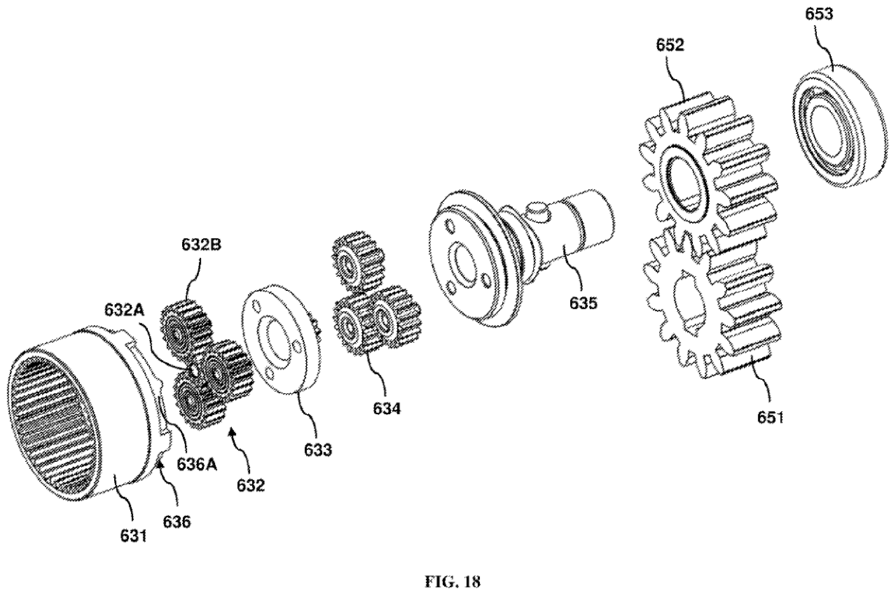

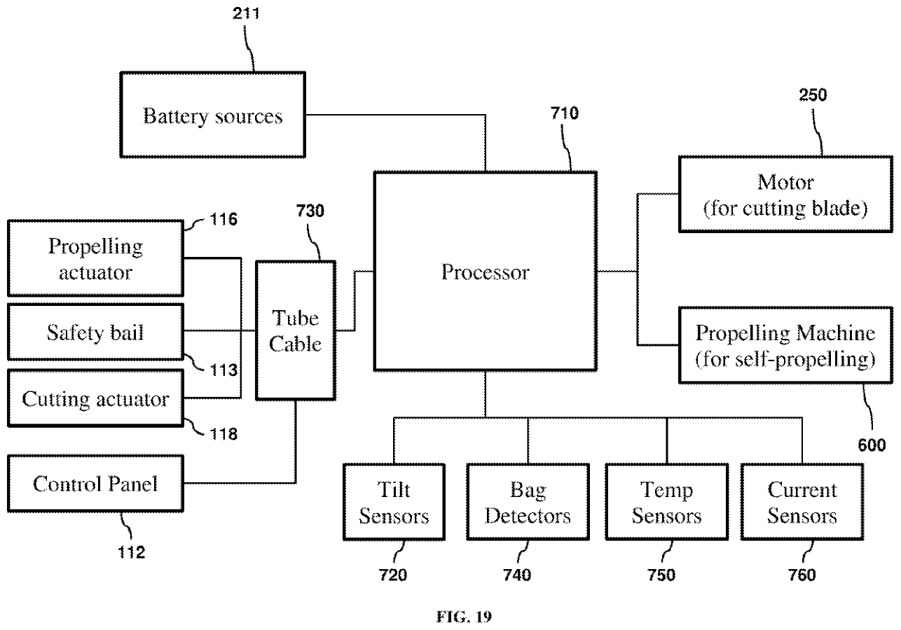

FIG. 18 illustrates the internal structure of the clutch assembly 630 in accordance with certain embodiments of the present disclosure. The clutch assembly 630 comprises a ring gear 631, a first planetary gear set 632, a planet carrier 633, and a second planetary gear set 634. The ring gear 631 comprises a circular detent track 636 having a plurality of circumferentially spaced detents 636A. The first planetary gear set 632 comprises a sun gear 632A and three planet gears 632B in meshing relationship. The driving torque from the driving motor 620 is inputted from the motor shaft 622 to the clutch assembly 630 via the sun gear 632A and coupled to the three planet gears 632B. The ring gear 631 is driven by the first planetary gear set 632 to rotate and drive the second planetary gear set 634, which in turn drives the planet carrier 633. The planet carrier 633 is coupled to the output shaft 635 for transferring the driving torque to the driving shaft 533.

When the operator activates the self-propelling mode by triggering the propelling actuator 116, an operative instruction is received by the electromagnetic actuator 612. The piston 613 is moved to the extended position by the electromagnetic actuator 612, and pushes the hook 615 to the first direction. The locking member 616 is pivotable with respect to clutch assembly 530 to an unlocked position. At the unlocked position, each individual protrusion 616C of the locking member 616 does not engage one of the detents 636A of the circular detent track 636, the ring gear 631 in moved by the driving motor 620.

When the operator activates the user-propelling mode by triggering the propelling actuator 116, an inoperative instruction is received by the electromagnetic actuator 612. The piston 613 is moved to the retracted position by the electromagnetic actuator 612, and pulls the hook 615 to the second direction. The locking member 616 is pivotable with respect to clutch assembly 530 to a locked position. At the locked position, the protrusion 616C engages the circular detent track 636 and the ring gear 631 is not allowed to rotate. The reset spring 617 is configured to bias the locking member 616 the unlocked position.

Next, hereinafter is explanation and description on the driving circuit of the lawn mower 10 in accordance with certain embodiments of the present disclosure.

FIG. 19 is a schematic block diagram of the lawn mower 10 with a smart cutting mode. A processor 710, or microcontroller, is configured to receive plural control signals and other status signals for controlling the operation of the motor 250 and the propelling machine 600.

The processor 710 may be implemented by hardware, software, firmware (e.g., processor microcode), or any combination thereof. When implemented in software or firmware, the program code or code segments to perform the necessary tasks may be stored in a machine-readable medium such as a non-transitory storage medium. A code segment may be coupled to another code segment or a hardware circuit by passing and/or receiving information, data, arguments, parameters, or memory contents. In certain examples, a microcontroller is used instead of the processor 710, which may include an integrated circuit chip having a microprocessor, a read only memory (ROM), interfaces for peripheral devices, timers, analog-to-digital converters and digital-to-analog converters, and other functional units.

The processor 710 receives power from the one or more battery sources 211, which are preferably rechargeable batteries provided in the lawn mower 10 and is described above in more detail with respect to FIG. 9. As the one or more battery sources 211 have limited battery capacity, a good power management is essential to ensure that the lawn mower 10 can effectively be used to mow the lawn without the need of recharging the battery sources 211 frequently.

As to provide an effective power management, the control panel 112 includes an operation mode selection. In certain embodiments, the lawn mower 10 is operable with two or more operation modes in associated with the motor 250, wherein the two or more operation modes include a smart cutting mode and a normal mode. The normal mode may comprise at least one of an economy mode where the motor 250 has a relatively moderate output and a power mode where the motor 250 has a maximum output, and intermediate modes where the motor 250 has intermediate outputs. In certain embodiments, there is speed feedback for the propelling machine 600. The control panel 112 may include a pace speed selector, which allows the operator to select the movement speed of the lawn mower 10 in self-propelling mode. Particularly, the speed of the propelling machine 600 is adjusted by applying a pulse width modulation (PWM) to the power supplied to the propelling machine 600. The duty of the PWM is adjustable based on the pace speed selector.

Other control signals, such as the actuator 116, the safety bail 113, and the cutting actuator 118 are transmitted from the handle 100 to the processor 710 via a tube cable 730. The processor 710 also receives a tilting signal from the tilt sensors 720 for determining whether the lawn mower 10 is raised to expose the cutting blade 521, and a bag detection signal from the bag detectors 740 for determining whether the grass collector 400 is installed. The bag detectors 740 may include steel reeds for verifying the connections between the grass collector 400 and the rear end 201B of the lawn mower 10. The processor 710 also receives measurement data from the one or more temperature sensors 750 for determining whether the motor 250 and the propelling machine 600 are overheated.

In certain embodiments, the one or more tilt sensors 720, including but not limited to, multi-axis accelerometers, gyroscopes, infrared sensors, motion sensors, or any combination thereof, are configured to detect the orientation of the lawn mower 10. When the lawn mower 10 is raised to expose the cutting blade 521, it is dangerous to have the cutting blade 521 rotating. The one or more tilt sensors 720 are configured to determine the tilt of the mower deck 201 to ensure that the electric power is supplied to the motor 250 and the propelling machine 600 when the cutting blade 521 is facing the ground surface. In other words, if the cutting blade 521 is not facing the ground surface, the electric power for the motor 250 is cut-off to prevent the cutting blade 521 from rotating. The movement of the handle 100 per se does not result in an electric power cut-off.

The operation modes in associated with the motor 250 are described in detail below. The economy mode is configured to reduce the motor's rotation speed. The power supplied to the motor 250 is smallest in the economy mode. As a non-limiting illustration, the motor 250 rotates at a low speed of 2,800 rotations per minute (RPM) in the economy mode.

The power mode is configured to increase the motor's rotation speed. The power supplied to the motor 250 is largest in the power mode. As a non-limiting illustration, the motor 250 rotates at a high speed of 3,300 RPM in the power mode.

The lawn mower 10 advantageously comprises a dynamic power management system for realizing the smart cutting mode. The dynamic power management system is configured to adjust a rotation speed of the motor 250 dynamically based on a duty condition of the cutting blade 521 such that the rotation speed R is a function F(IM) of a current IM supplied to the motor 250. Operator control of the rotation speed is not required. The dynamic power management system comprises one or more current sensors 760 for detecting the current supplied. The one or more current sensors 760 are attached to the current path to the motor 250 using a shunt resistor, a magnetic device, or other equivalent structures.

In certain embodiments, the function is monotonically increasing with respect to the current. For instance, the function F(IM) is selected from a group consisting of: an increasing step function, a continuous monotonically increasing function, a combination thereof, or other increasing function known to an ordinary person skilled in the art.

The processor 710 is configured to dynamically adjust the speed of the motor 250 in response to the change in load and current supplied. In operation, the one or more current sensors 760 is configured to continuously or regularly measure the current of the motor 250, and couple the measured current to the processor 710 or one or more operational amplifiers for comparing the measured current with a current consumption profile. The current consumption profile comprises a plurality of predetermined current ranges or thresholds representing at least a high current consumption and a low current consumption. Based on the current comparison, the processor 710 determines whether the current supplied to the motor 250 should be adjusted.

As a non-limiting illustration of the dynamic power management system, the motor 250 is first set to rotate at a low speed at 2,800 RPM. In a heavy duty condition, the load is increased and a higher current is required to drive the motor 250. The current sensed by the one or more current sensors 760 is increased. When the current of the motor 250 is higher than a first threshold at 14 A, the processor 710 is configured to increase the power supplied to the motor 250 by increasing the voltage applied, thereby the speed of the motor 250 is increased to a higher speed of 3,300 RPM. Similarly, in a low duty condition, the load is decreased and a lower current is required to drive the motor 250. The current sensed by the one or more current sensors 760 is decreased. When the current of the motor 250 is lower than a second threshold at lOA, the processor 710 is configured to decrease the power supplied to the motor 250 by lowering the voltage applied, thereby the speed of the motor 250 is decreased to a lower speed of 2,800 RPM. It should be noted that the numerals cited above are for illustrative purposes and are not meant to be a limitation of the present disclosure. It is also apparent that there may be more than two thresholds, and the thresholds are defined with hysteresis implemented.

This illustrates the fundamental structure and mechanism of the lawn mower in accordance with the present disclosure. It is apparent that the present disclosure may be embodied in other types of lawn mower or cutting apparatus without departing from the spirit or essential characteristics thereof. The present embodiment is, therefore, to be considered in all respects as illustrative and not restrictive. The scope of the disclosure is indicated by the appended claims rather than by the preceding description, and all changes that come within the meaning and range of equivalency of the claims are therefore intended to be embraced therein.

What is claimed is:

1. A lawn mower, comprising:
a mower deck;
a cutting blade rotatably mounted to the mower deck;
a motor for driving the cutting blade; and
a blade changing mechanism comprising:
a fastener for securing the cutting blade to the motor;
a blade securement tool for limiting the cutting blade from rotating in at least one direction; and
at least one opening at the mower deck for removably rece lvmg the blade securement tool.

2. The lawn mower of claim 1, wherein the blade securement tool limits the cutting blade from rotating in both directions.

3. The lawn mower of claim 1, wherein the blade changing mechanism comprises two spaced apart openings.

4. The lawn mower of claim 1, wherein the mower deck comprises a motor housing, the at least one opening is provided at the motor housing.

5. The lawn mower of claim 3, wherein the blade securement tool comprises a U-shaped piece with two side pins, the U-shaped piece crosses the cutting blade when the two side pins are received in the two openings.

6. The lawn mower of claim 5, wherein the U-shaped piece comprises a horizontal member connected between the two side pins, wherein the horizontal member has a length larger than a width of the cutting blade.

7. A lawn mower, comprising:
a mower deck;
a cutting blade rotatably mounted to the mower deck, the cutting blade defines a generally planar cutting area; and
an edge guide on the mower deck, the edge guide defines a channel extending from an area radially exterior to and below the cutting area to the cutting area.

8. The lawn mower of claim 7, wherein the edge guide comprises a vertically extending outer guide, the outer guide is radially away from and extends lower than the cutting area.

9. The lawn mower of claim 8, wherein the edge guide further comprises a combing structure at an inner side of the outer guide for combing and/or converging grass to the cutting area.

10. The lawn mower of claim 9, wherein the combing structure comprises one or more ribs, the one or more ribs divide the channel into two or more sub-channels.

11. The lawn mower of claim 10, wherein the one or more ribs extend at least partially in a radial direction.

12. The lawn mower of claim 10, wherein the two or more sub-channels are tortuous.

13. A lawn mower configured to be powered by one or more battery sources, the lawn mower comprising:
a cutting blade;
a motor for driving the cutting blade; and
a dynamic power management system configured to adjust a rotation speed of the motor dynamically based on a duty condition of the cutting blade such that the rotation speed is a function of a current supplied to the motor.

14. The lawn mower of claim 13, wherein the dynamic power management system comprises one or more current sensors configured to continuously or regularly measure the current of the motor.

15. The lawn mower of claim 14, wherein the lawn mower further comprises a processor having a current consumption profile and is configured to determine the rotation speed of the motor by comparing the current of the motor with the current consumption profile.

16. The lawn mower of claim 15, wherein the current consumption profile compnses a plurality of predetermined current ranges or thresholds representing at least a high current consumption and a low current consumption.

17. The lawn mower of claim 14, wherein the one or more current sensors are attached to a current path to the motor using a shunt resistor or a magnetic device.

18. The lawn mower of claim 13, wherein the function is selected from a group consisting of: an increasing step function, a continuous monotonically increasing function, or a combination thereof.
